(19) United States
(12) Patent Application Publication
(10) Pub. No.: US 2026/0074974 A1
(43) Pub. Date: Mar. 12, 2026

(54) SYSTEM AND METHOD FOR MANAGING ASYNCHRONOUS COMMUNICATION BETWEEN AN AI AVATAR AND HUMAN REPRESENTATIVE

(71) Applicant: 2hr Learning, Inc., Austin, TX (US)

(72) Inventors: Eric Vaughan, Galveston, TX (US); Thibault Bridel-Bertomeu, Bassins (CH)

(73) Assignee: 2hr Learning, Inc., Austin, TX (US)

(21) Appl. No.: 19/326,663

(22) Filed: Sep. 11, 2025

Related U.S. Application Data
(60) Provisional application No. 63/693,180, filed on Sep. 11, 2024.
(60) Provisional application No. 63/693,181, filed on Sep. 11, 2024.
(60) Provisional application No. 63/693,182, filed on Sep. 11, 2024.
(60) Provisional application No. 63/720,181, filed on Nov. 14, 2024.
(60) Provisional application No. 63/738,421, filed on Dec. 23, 2024.
(60) Provisional application No. 63/810,751, filed on May 23, 2025.

(51) Int. Cl. H04L 43/0811; H04L 51/02

(52) U.S. Cl. CPC H04L 43/0811; H04L 51/02

(57) ABSTRACT

The system and method for managing asynchronous communication between an AI avatar and a human representative upon detection of a network failure to establish a real-time connection. The asynchronous communication management process comprises the AI avatar that is configured to detect a connection failure when unable to establish or maintain a real-time connection with the human representative. The AI avatar sends a first notification message to prompt the human representative to provide the necessary information asynchronously. The AI avatar receives an asynchronous response message from the human representative including information relevant to the context of the interactive session. Updating a knowledge base of the AI avatar by parsing the received asynchronous response message. The AI avatar sends a second notification to the user through the communication channel to inform the user that the knowledge base has been successfully updated with the new information provided by the human representative.

### CROSS-REFERENCE TO RELATED APPLICATION

This application claims the benefit under 35 U.S. C. § 119(e) and 37 C.F. R. § 1.78 of the following U.S. Provisional Application Nos., which are all incorporated by reference in their entireties: 63/693,180 filed Sep. 11, 2024, 63/693,181 filed Sep. 11, 2024, 63/693,182 filed Sep. 11, 2024, 63/720,181 filed Nov. 14, 2024, 63/738,421 filed Jan. 6, 2025, and 63/810,751, filed Jun. 5, 2025.

### FIELD OF THE INVENTION

The present invention relates in general to the field of electronics, and more specifically to asynchronous communication managing systems and asynchronous communication management processes for managing asynchronous communication between AI avatars and human representatives upon detection of network failure to establish a real-time connection.

### BACKGROUND

A digital assistant is utilized to resolve the query of a user during an active session. Traditional digital assistants rely on synchronous communication, where the interaction between the digital assistant and the human counterpart associated with the digital assistant happens in real-time. This approach necessitates that both the digital assistant and the human counterpart be simultaneously active. If the user poses the query that the digital assistant is unable to answer immediately, the typical response is limited to either an error message or an inability to provide an answer. This leaves the responsibility of follow-up entirely on the user, often requiring them to revisit the same query at a later time. Such interruptions can lead to frustration, as they break the natural flow of the interaction and detract from the overall user experience.

The traditional digital assistant becomes problematic in scenarios where comprehensive answers are not readily available. For instance, in customer service applications, many queries may require additional information or clarification before they can be resolved. However, if the digital assistant cannot provide a resolution on the spot, the session usually concludes without achieving the desired outcome. This premature ending of interactions means the user has to re-engage with the digital assistant, repeating their query or starting from scratch in a new session. This repetition doubles the effort required from the user, making the process cumbersome and time-consuming.

Such inefficiencies extend beyond mere inconvenience, as they also impact the perception of digital assistants as reliable and effective tools. When the users are required to put in extra effort to obtain answers, it undermines the purpose of using the digital assistant in the first place, which is to simplify and streamline interactions. Additionally, the increased time to provide resolution caused by the traditional digital assistant can be particularly detrimental in high-stakes environments, such as technical support or medical advice, where timely and accurate responses are critical. Thus, the synchronous nature of the traditional digital assistants often falls short of meeting user expectations, particularly in complex or multifaceted use cases.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary asynchronous communication management system to manage asynchronous communication between an AI avatar and a human representative upon detection of a network failure to establish a real-time connection.

FIG. 2 depicts an exemplary asynchronous communication management process utilized by the asynchronous communication management system.

FIG. 3 depicts a data structure for updating the knowledge base based on the first notification message.

FIGS. 4-6 are exemplary user interfaces depicting the interaction of the AI avatar with the human representative.

FIG. 7 depicts an exemplary network environment in which the system of FIG. 1 and the process of FIG. 2 may be practiced.

FIG. 8 depicts an exemplary computer system.

### DETAILED DESCRIPTION

An asynchronous communication system and method manages asynchronous communication between an AI avatar and a human representative upon detection of a network failure to establish a real-time connection. The asynchronous communication management system and method include AI avatar that is configured to detect a connection failure when unable to establish or maintain a real-time connection with the human representative. The AI avatar sends a first notification message to prompt the human representative to provide the necessary information asynchronously. The AI avatar receives an asynchronous response message from the human representative including information relevant to the context of the interactive session. Updating a knowledge base of the AI avatar by parsing the received asynchronous response message. The AI avatar sends a second notification to the user through the communication channel to inform the user that the knowledge base has been successfully updated with the new information provided by the human representative.

Moreover, the communication channels utilized for sending the first notification message can include mobile application notifications or emails directed to the associated accounts of the human representative. The communication channels ensure prompt delivery of the first notification message, facilitating quick responses from the human representative. Additionally, the method employs a network monitoring module to consistently track connectivity between the AI avatar and the representative, instantly detecting any disruptions. The AI avatar also uses a connection monitoring algorithm that checks the network status for issues like latency or packet loss, triggering the necessary notifications to maintain communication.

Moreover, updating the knowledge base of the AI avatar when the asynchronous response message is received from the human representative. The AI avatar processes the asynchronous response message by parsing the response, analyzing its relevance to the ongoing session, and integrating it into the knowledge base. This involves context analysis to ensure that the new information is appropriately categorized and indexed, enhancing the accuracy of the AI avatar in future queries.

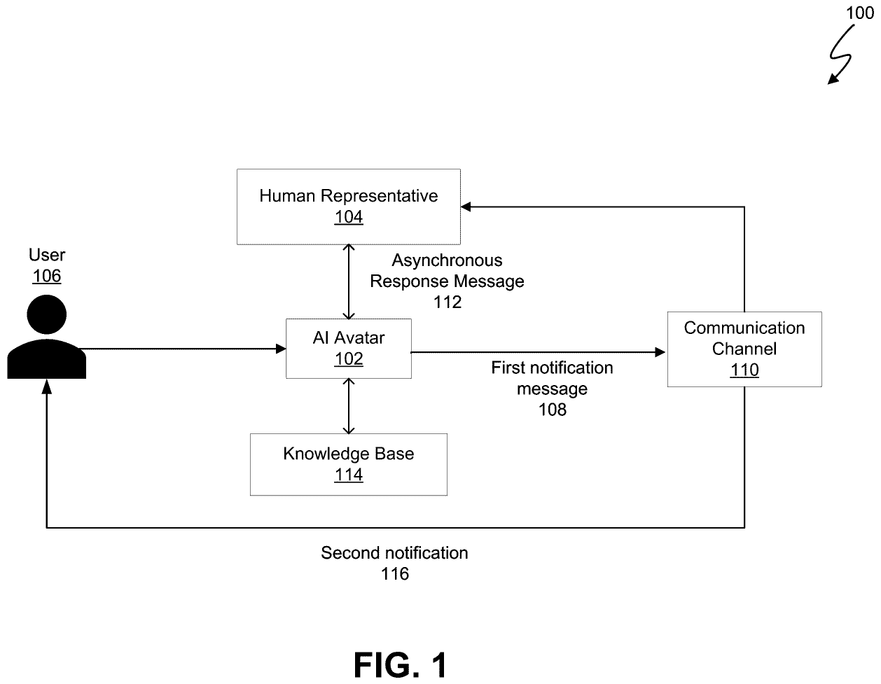

FIG. 1 depicts an exemplary asynchronous communication management system 100 to manage asynchronous communication between an AI avatar 102 and a human representative 104 upon detection of a network failure to establish a real-time connection.

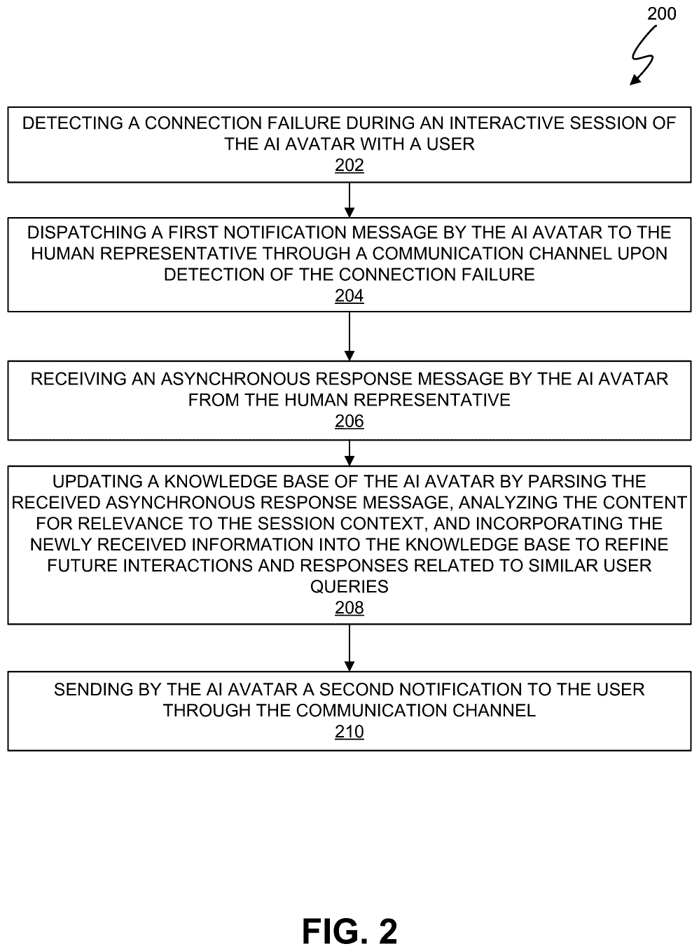

FIG. 2 depicts an exemplary asynchronous communication management process 200 utilized by the asynchronous communication management system 100.

The asynchronous communication management system 100 and asynchronous communication management process 200 are configured to manage communication between the AI avatar 102 and the human representative 104 when a real-time connection fails during an interactive session. It involves detecting the connection failure while the AI avatar 102 continuously monitors the network status. Upon detection, the AI avatar 102 alerts the human representative 104, prompting the human representative 104 to provide information asynchronously.

Referring to FIGS. 1 and 2, in operation 202, detecting a connection failure during an interactive session of the AI avatar 102 with a user 106. Typically, detecting the connection failure during the interactive session enables seamless interaction and ensures uninterrupted communication between the AI avatar 102 and the human representative 104. In the interactive session, the AI avatar 102 serves as an intelligent, responsive interface designed to communicate with the user 106, responding to questions, providing guidance, and facilitating real-time support. The interaction allows the AI avatar 102 to create a lifelike and personalized experience for the user 106. The AI avatar 102 continuously monitors a network status associated with the session with the human representative 104 and identifies an inability to establish or maintain a direct, real-time connection. To provide a personalized experience for the user 106, the AI avatar 102 is able to identify and manage any connectivity issues that may arise, such as uninterrupted communication.

The AI avatar 102 is configured to continuously monitor the network status to ensure that the AI avatar 102 remains aware of any fluctuations or interruptions in network performance. Through monitoring, the AI avatar 102 observes various metrics associated with connectivity, such as latency, bandwidth, and signal strength, which provide insights into the stability of the connection. By analyzing these indicators in real time, the AI avatar 102 can detect even subtle signs of connection deterioration, such as lagging response times or unexpected delays. This detection empowers the AI avatar 102 to respond proactively to potential disconnections with the human representative 104. The network status refers to the various aspects of the internet or intranet connection that support the communication of the AI avatar 102 with the human representative 104. The network status encompasses elements such as connection quality, stability, and availability which are integral for maintaining a smooth and responsive interaction with the human representative 104.

The AI avatar 102 monitors the network status associated with the session with the human representative 104. Once the connection is established, the AI avatar 102 maintains a stable link and ensures that information is exchanged between the AI and the human representative 104 without interruption. Typically, real-time connectivity is important in cases where timely responses are critical, such as customer support or technical troubleshooting. The real-time connection allows the AI avatar 102 to provide immediate feedback, simulating a live conversation.

Moreover, the connection failure is detected by a network monitoring module configured to continuously track connectivity status between the AI avatar 102 and the human representative 104 during the session. The network monitoring module is configured to continuously monitor the connectivity status between the AI avatar 102 and the human representative 104 throughout the entire session. The network monitoring module tracks the connection status in real time, ensuring that any issues are promptly identified and managed. By operating continuously, the network monitoring module offers an uninterrupted evaluation of network health for maintaining a seamless and responsive interaction between the AI avatar 102 and the human representative 104.

The network monitoring module functions by analyzing key indicators of connection stability, such as latency, bandwidth, signal strength, and packet loss. The indicators provide a detailed snapshot of the network's performance at any given moment, allowing the network monitoring module to assess the quality and reliability of the connection. If the network monitoring module detects any anomalies such as a sudden drop in bandwidth, high latency, or an increase in packet loss, the module identify the anomaly as a connection failure. This continuous monitoring and analysis allow the network monitoring module to identify and react to connection issues as they develop, often before they escalate to a complete disconnection. This enables the AI avatar 102 to respond appropriately and ensure the user experience remains as smooth and uninterrupted as possible.

During the session, the AI avatar 102 and the human representative 104 rely on an active and stable connection to communicate effectively. Even minor disruptions in the connectivity can affect the response of the AI avatar 102, causing delays or interruptions in information exchange. For example, if the latency exceeds a certain level or if packet loss reaches a predefined percentage, the network monitoring module recognizes this as a signal of deteriorating connection quality. By setting these thresholds, the network monitoring module can differentiate between minor fluctuations, which are often harmless, and more severe disruptions that could hinder communication.

In operation 204, dispatching a first notification message 108 by the AI avatar 102 to the human representative 104 through a communication channel 110 upon detection of the connection failure. The first notification message 108 prompts the human representative 104 to provide requested information asynchronously due to the absence of a real-time connection. Upon detecting the connection failure, the AI avatar 102 initiates dispatching the first notification message 108 to the human representative 104 via the communication channel 110. The AI avatar 102 immediately triggers the first notification message 108 an automated response, which conveys to the human representative 104 that a connectivity issue has been identified, and that direct, real-time interaction is momentarily unavailable.

The first notification message 108 is crafted to be clear, direct, and informative, providing essential guidance on how the human representative 104 should proceed. The first notification message 108 prompts the human representative 104 to respond in the asynchronous manner, meaning that the human representative 104 can continue the exchange by supplying requested information at their convenience rather than in a continuous, live exchange. By requesting information asynchronously, the AI avatar 102 ensures that the interaction of the user 106 with the AI avatar 102 can remain productive and timely responses are provided to the user 106.

The communication channel 110 is the medium through which the AI avatar 102 reaches the human representative 104. The communication channel 110 may include various forms such as email, a messaging application, or Short Messaging Service (SMS), elected based on their accessibility and reliability in conditions with connectivity issues. The communication channel 110 is designed to remain operational even when the real-time connection is lost, thus providing a fail-safe route for the AI avatar 102 to relay inputs such as the queries of the user 106 to the human representative 104. By selecting the resilient communication channel 110, the AI avatar 102 ensures that the first notification message 108 will reach the human representative 104 promptly and that the human representative 104 will be able to respond in a timely manner, sustaining the interaction effectively.

Upon detecting a connectivity issue, the AI avatar 102 initiates the transmission of the first notification message 108 to the human representative 104 through one or more communication channels 110. The communication channels 110 include a mobile application message and an email message directing the first notification message 108 to the associated mobile application and email address of the human representative 104, respectively. The communication channel 110 is selected to ensure that the human representative 104 is notified in a timely and reliable manner. The mobile application message directed the first notification message 108 to the mobile application associated with the account of the human representative 104. The mobile application is typically an extension that the human representative 104 uses to manage communications with the AI avatar 102. The mobile application serves as an effective communication channel 110 due to its capability to provide push notifications, which immediately alert the human representative 104.

The email message is also directed to the email address associated with the account of the human representative 104. By sending the first notification message 108 to the email address, of the human representative 104, the AI avatar 102 ensures that the first notification message 108 can be accessed on a desktop, tablet, or any other internet-connected device that supports email. In at least one embodiment, the first notification message 108 includes information on the connectivity issue, any relevant session information required by the AI avatar 102, and guidance on how the human representative 104 can proceed asynchronously if real-time communication is not feasible. The combination of mobile application messages and email effectively addresses potential challenges in delivering time-sensitive information.

The AI avatar 102 employs a connection monitoring algorithm designed to maintain standards of connectivity and ensure smooth, uninterrupted interaction with the human representative 104. The connection monitoring algorithm performs either continuous or interval-based checks of the network status, depending on the specific requirements of the session. The connection monitoring algorithm detects any network failure or instability that disrupts the connection. The connection monitoring algorithm tracks network latency, packet loss, and disconnection events. The latency refers to the time taken for data to travel from the AI avatar 102 to the human representative 104 and back. The packet loss refers to instances when data packets fail to reach their destination, resulting in gaps in the transmitted information. The packet loss can impact the quality of communication, causing the first notification message 108 to become incomplete or distorted.

The connection monitoring algorithm quickly detects when there is complete disconnection, where the network connection drops entirely. Upon identifying the connection failure, the connection monitoring algorithm is configured to immediately trigger the dispatch of the first notification message 108. The first notification message 108 informs the human representative 104 about the detected connection issue, providing essential details on the nature and status of the network disruption. The first notification message 108 serves as an alert and also provides an essential link between the AI avatar 102 and the human representative 104, ensuring that both remain informed about the connection's status. The first notification message 108 is sent through the communication channel 110, such as the mobile application message or the email, which are reliable and accessible. By dispatching the first notification message 108, the connection monitoring algorithm ensures that the human representative 104 responds asynchronously, allowing the interaction to continue without disruptions.

When the connection issue is detected, the AI avatar 102 promptly dispatches the first notification message 108 to the human representative 104. The first notification message 108 is designed to inform the human representative 104 about the connectivity problem and also offer comprehensive guidance on how to navigate the reconnection process. The first notification message 108 includes a step-by-step outline of how the human representative 104 can attempt to reconnect. This involves instructions on checking the network settings, restarting the communication platform, or verifying internet connectivity. For example, the AI avatar 102 may suggest that the human representative 104 switches from a Wi-Fi to a cellular network if possible or even try accessing a different network altogether. By offering practical troubleshooting steps tailored to common connectivity issues, the AI avatar 102 provides the human representative with immediate solutions to successfully reconnect.

Moreover, the first notification message 108 provides information about alternate communication channel 110 through which the human representative 104 can continue to submit responses if reconnection efforts are delayed or unsuccessful. For example, the first notification message 108 may instruct the human representative 104 to submit responses via email. The first notification message 108 includes information on how to contact technical support for additional assistance if reconnection proves difficult. The AI avatar 102 identifies some issues that may require specialized support. The first notification message 108 is crafted to be clear, concise, and easily actionable, allowing the human representative 104 to follow the instructions with minimal effort. In at least one embodiment, the first notification message 108 employs bullet points or numbered lists to break down each step of the reconnection process, or key phrases may be bolded or highlighted to draw attention to critical actions

In operation 206, receiving an asynchronous response message 112 by the AI avatar 102 from the human representative 104. The response message 112 includes information relevant to the context of the interactive session of the AI avatar 102 with the user 106 and is received via the communication channels 110 for asynchronous interaction. The AI avatar 102 receives the asynchronous response message 112 from the human representative 104 to maintain continuity within the interactive session with the user 106 when real-time connectivity is not possible. The asynchronous response message 112 enables the human representative 104 to provide information relevant to the ongoing session at their convenience. By supporting asynchronous communication, the AI avatar 102 can receive, process, and respond to the response message 112, thereby sustaining the interaction. The asynchronous response message 112 delivers information that the human representative 104 considers essential to the session. The response message 112 includes status updates, responses to questions posed earlier by the AI avatar 102, additional details that expand on prior discussions of the AI avatar 102 with the user 106, or specific data that enrich the context of the interaction. Since the AI avatar 102 cannot always rely on uninterrupted real-time communication, the asynchronous response message bridges potential gaps in the interaction by allowing the representative to share insights, instructions, or feedback later, thus preserving the flow of information.

The response message 112 allows the AI avatar 102 to process and incorporate new information relevant to the session. Typically, each response message 112 helps to guide the AI avatar 102 in responses and decision-making processes. The AI avatar 102 parses the response message 112 to extract key details, identifies any follow-up actions needed and ensures that the information is seamlessly integrated into the ongoing interaction, creating a continuous and cohesive experience for the user 106. The interactive session is characterized by a flow of information from the AI avatar 102 to the user 106. During, the session the AI avatar 102 supports the user 106 by providing answers, collecting data from human representative 104 when AI avatar is unable to provide the answer, assisting in decision-making, or solving problems. The asynchronous response message 112 ensures that the session remains uninterrupted, even when live communication is unachievable. The relevant information may include specific instructions, contextual details, data points, or clarifications that the human representative 104 provides to the AI avatar 102 to allow, the AI avatar 102 to proceed with the session accurately. The asynchronous response message 112 is transmitted through the communication channel 110 to the AI avatar 102.

In operation 208, updating a knowledge base 114 of the AI avatar 102 by parsing the received asynchronous response message 112, analyzing the content for relevance to the session context, and incorporating the newly received information into the knowledge base 114 to refine future interactions and responses related to similar user queries. The knowledge base 114 is a centralized collection of information that the AI avatar 102 uses to answer questions, provide guidance, and engage in interactions with the user 106. The knowledge base 114 includes data, context-specific insights, user preferences, past interactions, and any other relevant information that contributes to effective communication. Typically, the knowledge base 114 continuously evolves, as it incorporates new details and experiences with each session. Moreover, updating the knowledge base 114 ensures that the AI avatar 102 is well-informed and capable of offering responses that are accurate, contextually relevant, and aligned with the expectations of the user 106. By adding information from the asynchronous response messages 112, the AI avatar 102 creates a richer, nuanced repository that supports deeper and insightful engagement with the user(s) 106.

To update the knowledge base 114, the AI avatar 102 parses the received asynchronous response message 112. The parsing involves breaking down the response message 112 into core components, extracting specific details, and identifying key themes or phrases that carry relevance to the session context. The parsing allows the AI avatar 102 to understand the exact nature of the information provided by the human representative 104, such as instructions, feedback, or context-specific data. By parsing the response message 112, the AI avatar 102 can isolate the critical elements that need to be added to the knowledge base 114, ensuring that only the most pertinent information is retained. Furthermore, updating the knowledge base 114 by analyzing the content of the response message 112. The updating the knowledge base 114 involves interpreting the information within the context of the current interaction, comparing the response message 112 with existing knowledge, and evaluating its applicability to the specific session and potential future interactions. For example, if the response message 112 contains specific preferences, troubleshooting steps, or clarifications on a user query, the AI avatar 102 examines these details to see how they align with interactions.

After analyzing the relevance of the content, the AI avatar 102 incorporates the newly received information into the knowledge base 114. The incorporation involves updating existing data, adding new entries, and modifying any outdated or inaccurate information. Typically, incorporating the data ensures that the knowledge base 114 remains a reliable source of information for the AI avatar 102. The knowledge base 114 updates the AI avatar 102 to refine future interactions and responses related to similar user queries. As the knowledge base 114 grows richer with each update, it becomes more capable of understanding user intents, recognizing recurring patterns, and delivering responses that align with the expectations and preferences of the user 106. The refinement enables the AI avatar 102 to continuously learn from each interaction, evolving its approach to ensure that it remains relevant and responsive. Moreover, incorporating new information into the knowledge base 114 also allows the AI avatar 102 to enhance contextual understanding. The contextual understanding involves recognizing the specifics of the user query and also the underlying needs and circumstances that may inform that query. In addition, updating the knowledge base 114 enables the AI avatar to enhance its adaptability, making it capable of handling a wide array of queries and requests. As the knowledge base 114 incorporates new and varied information, the scope of understanding of the AI avatar 102 expands, allowing it to address a broader range of user issues.

Moreover, updating the knowledge base 114 involves a data processing algorithm executed by the AI avatar 102 to parse and analyze the content of the response message 112 provided by the human representative 104, extract specific information relevant to the session, and incorporate the extracted information into a structured, query-specific knowledge base 114 entry, thereby enhancing the ability of the AI avatar 102 to address similar queries with improved accuracy in future sessions. Typically, the data processing algorithm initiates by parsing and analyzing the content of the response message 112 provided by the human representative 104. The parsing involves dissecting the incoming response message 112 into distinct components, such as key phrases, terms, or specific instructions that relate to the ongoing session. By breaking down the response message 112 content, the data processing algorithm simplifies the information into manageable units that can be more easily assessed.

Following the parsing, the data processing algorithm analyzes the parsed content by interpreting the meaning of each element and determining its relevance to the ongoing query or problem being addressed. For example, if the human representative 104 message contains troubleshooting steps or user-specific preferences, the data processing algorithm evaluates how this new data aligns with previously recorded interactions or known patterns. Once the parsing and analysis are done, the data processing algorithm extracts specific information relevant to the session. The extraction involves isolating the elements within the response message 112 that are directly applicable to the current and future performance of the AI avatar 102. The extracted information includes insights into user preferences, frequently encountered issues, particular troubleshooting methods, or common solutions that can address similar queries in the future. The extraction capabilities allow the data processing algorithm to capture and store relevant data, optimizing the knowledge base 114 by focusing on information that can enhance the response accuracy of the AI avatar 102.

After extracting the relevant data, the data processing algorithm incorporates the extracted information into a structured, query-specific knowledge base 114 entry. The data processing algorithm organizes the newly acquired information into a format that the AI avatar 102 can readily access and retrieve in future sessions. Each entry within the knowledge base 114 is structured around specific query types or topics, meaning that similar queries are grouped together for quick reference. By structuring the knowledge base 114 allows the AI avatar 102 to pull relevant information quickly and efficiently to respond to user inquiries with greater accuracy. In at least one embodiment, the structured entry may include metadata such as keywords, query categories, and context tags, to enhance the ability of the AI avatar 102 to recognize and match relevant entries when addressing a similar question.

In operation 210, sending by the AI avatar 102 a second notification 116 to the user 106 through the communication channel 110. The second notification 116 informs the knowledge base 114 has been successfully updated with the new information provided by the human representative 104, thereby enabling the user 106 to stay informed regarding the updated state and knowledge content of the AI avatar 102 for subsequent interactions. The second notification 116 is a specific message crafted by the AI avatar 102 to inform the user 106 about updates to the knowledge base 114. The purpose of the second notification 116 is to convey essential information about changes that have been made to the knowledge base 114 of the AI avatar 102. The second notification 116 assures that the query asked by the user 106 during the session has been incorporated as provided by the human representative 104. The second notification 116 is transmitted to the user 106 via the communication channel 110. The communication channel 110 may vary depending on user preferences, potentially including email, in-app notifications, SMS, or so forth.

The second notification 116 informs the user 106 that the knowledge base 114 has been successfully updated with new information provided by the human representative 104. Each update to the knowledge base 114 refines the understanding of the AI avatar 102. By incorporating new data, the AI avatar 102 strengthens its capacity to respond accurately and contextually in future interactions. The second notification 116 enables the user 106 to stay informed regarding the updated state and knowledge base 114 of the AI avatar 102.

Below is the pseudo-code that describes a series of functions designed to manage sessions where the user 106 interacts with the AI avatar 102 also the AI avatar 102 maintains communication with the human representative 104 during potential network disruptions and updates the knowledge base of the AI avatar 102.
function handleSession(userQuery):
   if not isConnected( ):
      dispatchMessages( )
   response=waitForHumanInput( )
   updateKnowledgeBase(response)
   notifyUserOfUpdate( )
function isConnected( ):
   return checkNetworkStatus( )
function dispatchMessages( ):
   sendEmail( )
   sendMessageToApp( )
function updateKnowledgeBase(info):
   knowledgeBase.update(info)
function notifyUserOfUpdate( ):
   sendEmailEpdate( )

The function handleSession(userQuery) manages the user session. It processes the query of the user 106 handling potential connection issues and updates the knowledge base 114 of the AI avatar 102 with new information. if not isConnected( ) checks if the AI avatar 102 is currently connected to the network. If it isn't, the dispatchMessages( ) function is called to notify about the connectivity issue.

The response=waitForHumanInput( ) function waits for response message 108 from the human representative 104 after handling any connection issues, indicating that the AI avatar 102 requires human intervention to continue processing the query of the user 106. updateKnowledgeBase(response) is used to update the knowledge base 114 of the AI avatar 102 to learn from the input from the human representative 104. The notifyUserOfUpdate( ) sends a notification to the user 106 to inform him about the update.

The function isConnected( ) determines the current network status. The return checkNetworkStatus( ) to evaluate whether the AI avatar 102 is connected to the network. The function dispatchMessages( ) handles the asynchronous communication required when the AI avatar 102 is not connected. The sendEmail( ) sends an email to notify the human representative 104 about the issue and provides instructions or updates related to the session. The sendMessageToApp( ) sends a message through an associated mobile or web application to ensure the human representative 104 is informed through multiple communication channels 110.

The function updateKnowledgeBase(info) integrates new information into the knowledge base 114 of the AI avatar 102. The knowledgeBase. update(info) uses the provided input (info) to update the knowledge base 114 to ensure that the AI avatar 102 learns from the latest session and incorporates new insights for future interactions.

The function notifyUserOfUpdate( ) communicates with the user 106 after the knowledge base 114 has been updated. The sendEmailUpdate( ) sends an email such as the second notification 116 to the user 106 to inform that the knowledge base 114 has been successfully updated.

The notification handling algorithm is designed to provide the user 106 with seamless updates about changes in the knowledge base 114. The notification handling algorithm triggers the second notification 116 for the user 106 who initiated the session, ensuring that the update is relevant, personalized, and directly connected to their recent interaction. The second notification 116 is a targeted communication that informs the user 106 of the exact updates made in the knowledge base 124, based on new information provided by the human representative 104 during the session. For example, if the user 106 sought technical assistance during the session, and the human representative 104 provided new troubleshooting details that were subsequently added to the knowledge base 114, the second notification 116 outlines these specific troubleshooting steps.

By deploying the notification handling algorithm, the AI avatar 102 can accurately identify when the second notification 116 is needed and ensure that the second notification 116 reaches the intended user 106 without delay. The notification handling algorithm enables the AI avatar 102 to operate at scale, handling multiple user 106 interactions and updates simultaneously while maintaining individualized communication. The efficiency is important in environments, where the AI avatar 102 interacts with numerous users.

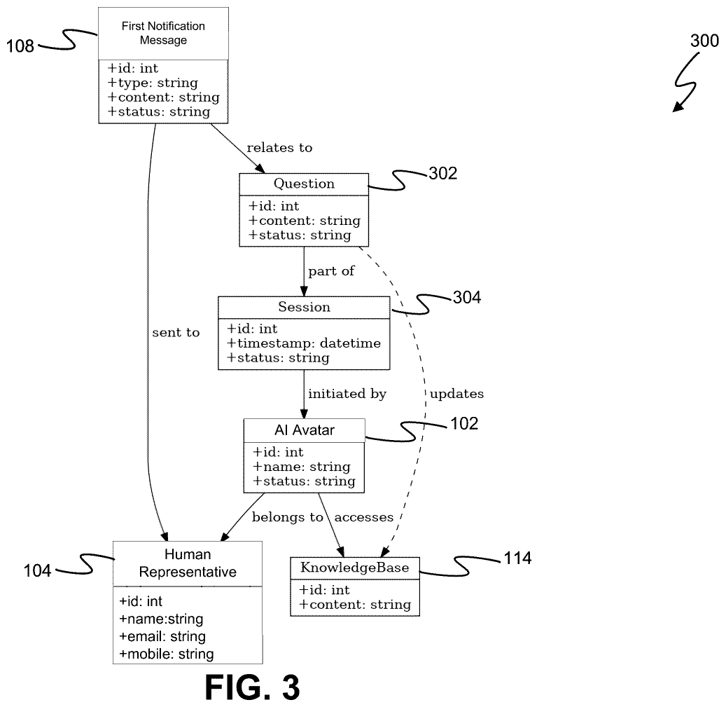

FIG. 3 depicts a data structure 300 for organizing data related to updating the knowledge base 114 based on the first notification message 108. The data structure 300 includes the first notification message 108 node, which stores detailed information related to id, type, content, and status of first notification message. The id is a unique identifier used to distinguish the first notification message 108. The type specifies the category or classification of the first notification message 108. The content represents the actual information contained within the first notification message 108. The status indicates the current state of the first notification message 108. The first notification message 108 relates to a question 302. The question 302 includes id, content, and status. The id is a unique identifier used to distinguish the question 302. The content represents the actual information contained within the question 302. The status indicates the current state of the question 302. The question 302 is a part of session 304. The session 304 includes id, timestamp, and status. The id is a unique identifier used to distinguish the session 304. The timestamp is a time at which the session 304 is initiated. The status indicates the current state of the session 304.

The session 304 is initiated by the AI avatar 102. The AI avatar 102 includes id, name, and status. The id is a unique identifier used to distinguish the AI avatar 102. The name refers to a unique name provided to the AI avatar 102. The status indicates the current state of the AI avatar 102. The AI avatar 102 belongs to the human representative 104 and also the first notification message 108 is also sent to the human representative 104. The human representative 104 includes id, name, email and mobile. The id is a unique identifier used to distinguish the human representative 104. The name is used for identification of the human representative 104. The email is a unique address used for communication with the human representative 104. The mobile is a contact number associated with the human representative 104. The AI avatar 102 accesses the knowledge base 114. The knowledge base 114 includes id and content. The id is a unique identifier used to distinguish information from the knowledge base 114. The content refers to the information contained within the knowledge base 114. The first notification message 108 is related to the question 302 and is used to update the knowledge base 114.

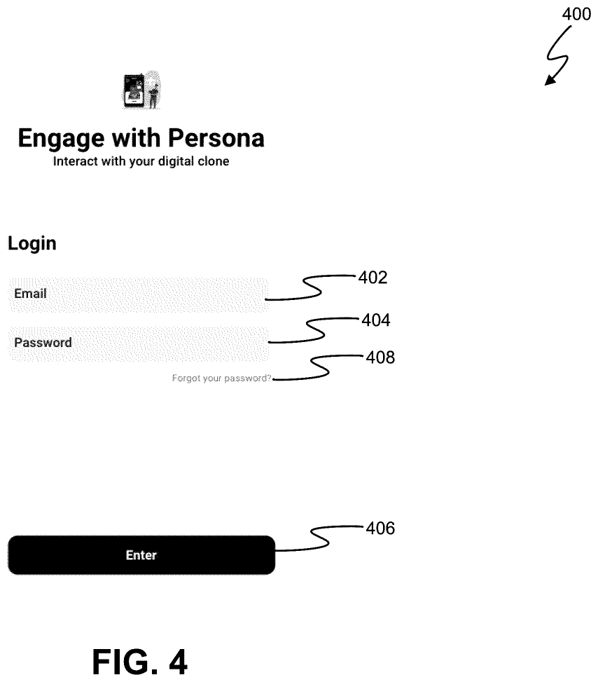

FIGS. 4-6 are exemplary user interfaces 400, 500, and 600 depicting the interaction of the AI avatar 102 with the human representative 104. Referring to FIG. 4 depicts the user interface 400 showing the login screen titled ‘Engage with Persona’ which prompts the human representative 104 to interact with the AI avatar 102. The user interface 400 shows fields for email 402 and password 404 entry. The human representative 104 provides the credentials such as email 402 and password 404 to interact with the AI avatar 102, once provided the human representative 104 press an enter button 406. In case the human representative 104 forgot the password 404, the human representative 104 can recover the password 404 by clicking on a forgot your password tab 408.

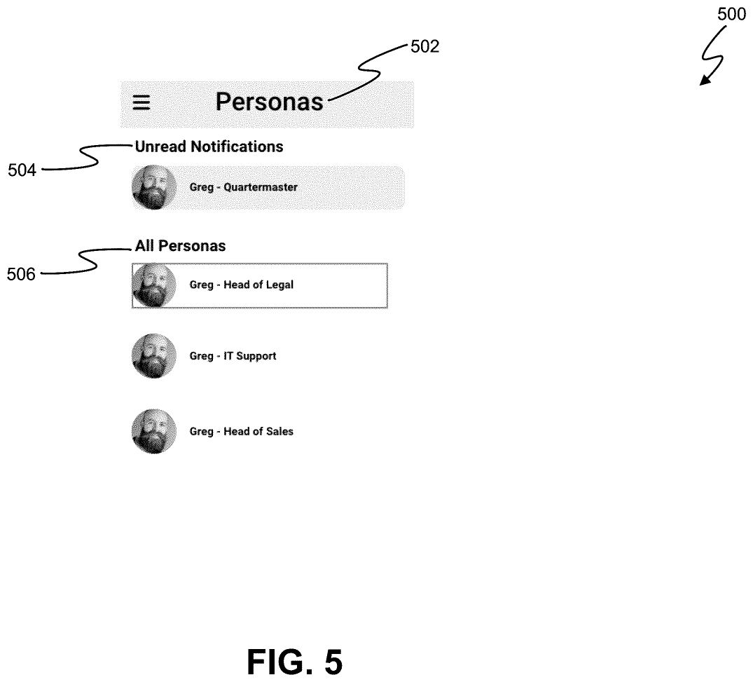

Referring to FIG. 5 depicts the user interface 500, displaying persona 502 (also referred as AI avatar 102) associated with the human representative 104 upon successfully logging in. The user interface 500 displays unread notification tab 504 to display unread notifications received from the persona 502. Moreover, the user interface 500 also displays all persona tab 506 to display all the associated persona 502 to the human representative 104.

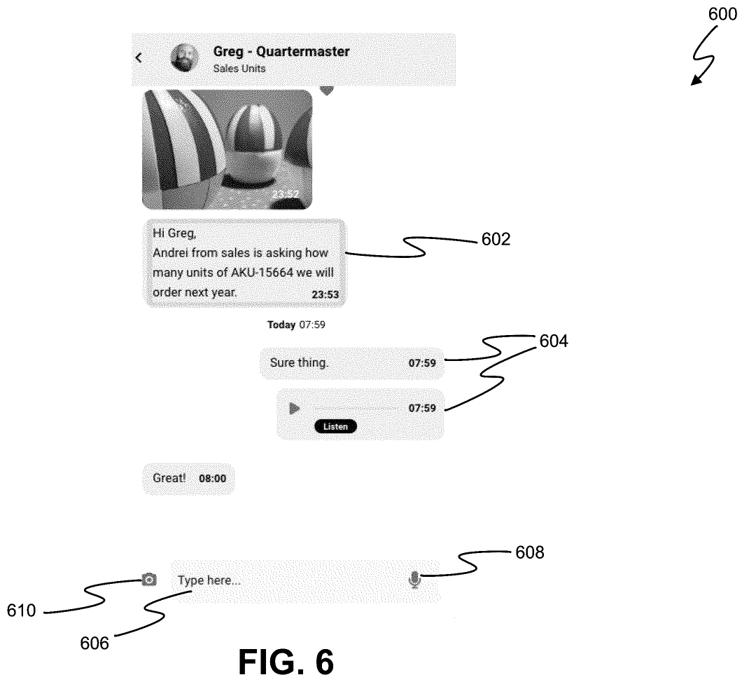

Referring to FIG. 6 depicts the user interface 600 showing the interaction between the persona 502 and human representative 104 upon clicking on the unread notifications received from the persona 502. The user interface 600 displays a query 602 received from the persona 502 and a response 604 provided by the human representative to the query 602. The user interface 600 allows the human representative 104 by typing in a message box 606 to provide the response 604. The human representative 104 can also provide the response 604 through a voice message by clicking on a record tab 608. Moreover, the human representative 104 can also provide the response 604 through an image by clicking on an upload image tab 610.

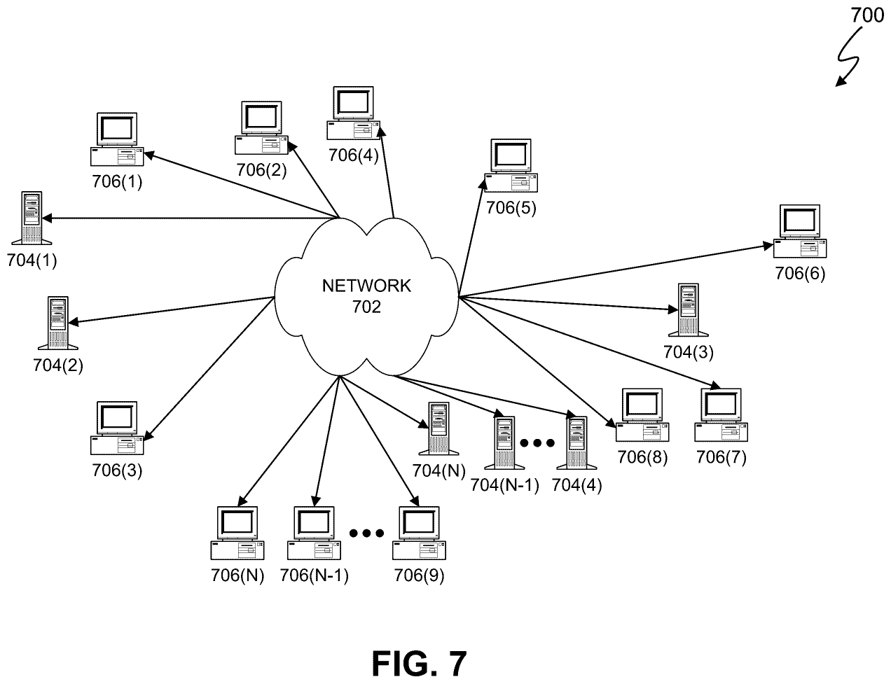

FIG. 7 is a block diagram illustrating a network environment in which an asynchronous communication management system 100 and asynchronous communication management process 200 may be practiced. Network 702 (e.g. a private wide area network (WAN) or the Internet) includes a number of networked server computer systems 704(1)-(N) that are accessible by client computer systems 706(1)-(N), where N is the number of server computer systems connected to the network. Communication between client computer systems 706(1)-(N) and server computer systems 704(1)-(N) typically occurs over a network, such as a public switched telephone network over asynchronous digital subscriber line (ADSL) telephone lines or high-bandwidth trunks, for example communications channels providing T1 or OC3 service. Client computer systems 706(1)-(N) typically access server computer systems 704(1)-(N) through a service provider, such as an internet service provider (“ISP”) by executing application specific software, commonly referred to as a browser, on one of client computer systems 706(1)-(N).

Client computer systems 706(1)-(N) and/or server computer systems 704(1)-(N) are specialized computer programmed to improve conventional computer systems to implement and utilize the asynchronous communication management system 100 and asynchronous communication management process 200. The type of computer system that can be specially programmed to implement and utilize the asynchronous communication management system 100 and asynchronous communication management process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the asynchronous communication management system 100 and asynchronous communication management process 200 can be implemented using code stored in a tangible, non-transient computer readable medium and executed by one or more processors. In at least one embodiment, the asynchronous communication management system 100 and asynchronous communication management process 200 can be implemented completely in hardware using, for example, logic circuits and other circuits including field programmable gate arrays.

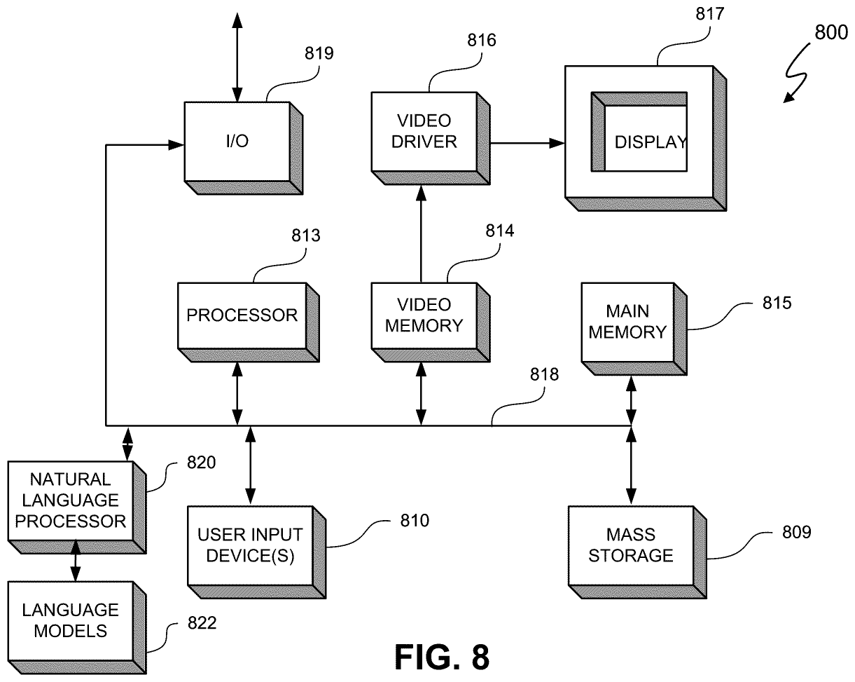

Embodiments of the asynchronous communication management system 100 and asynchronous communication management process 200 can be implemented on a computer system such as a special-purpose, special-programmed computer 800 illustrated in FIG. 8. Input user device(s) 810, such as a keyboard and/or mouse, are coupled to a bi-directional system bus 818. The input user device(s) 810 are for introducing user input to the computer system and communicating that user input to processor 813. The computer system of FIG. 8 generally also includes a non-transitory video memory 814, non-transitory main memory 815, and non-transitory mass storage 809, all coupled to bi-directional system bus 818 along with input user device(s) 810 and processor 813. The mass storage 809 may include both fixed and removable media, such as a hard drive, one or more CDs or DVDs, solid state memory including flash memory, and other available mass storage technology. Bus 818 may contain, for example, 32 of 64 address lines for addressing video memory 814 or main memory 815. The system bus 818 also includes, for example, an n-bit data bus for transferring DATA between and among the components, such as CPU 809, main memory 815, video memory 814 and mass storage 809, where “n” is, for example, 32 or 64. Alternatively, multiplex data/address lines may be used instead of separate data and address lines.

I/O device(s) 819 may provide connections to peripheral devices, such as a printer, and may also provide a direct connection to a remote server computer systems via a telephone link or to the Internet via an ISP. I/O device(s) 819 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 809, into main memory 815 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 813, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 815 is includes dynamic random access memory (DRAM). Video memory 814 is a dual-ported video random access memory. One port of the video memory 814 is coupled to video amplifier 816. The video amplifier 816 is used to drive the display 817. Video amplifier 816 is well known in the art and may be implemented by any suitable means. This circuitry converts pixel DATA stored in video memory 814 to a raster signal suitable for use by display 817. Display 817 is a type of monitor suitable for displaying graphic images.

The computer system described above is for purposes of example only. The asynchronous communication management system 100 and asynchronous communication management process 200 may be implemented in any type of computer system or programming or processing environment. It is contemplated that the asynchronous communication management system 100 and asynchronous communication management process 200 might be run on a stand-alone computer system, such as the one described above. The asynchronous communication management system 100 and asynchronous communication management process 200 might also be run from a server computer systems system that can be accessed by a plurality of client computer systems interconnected over an intranet network. Finally, the asynchronous communication management system 100 and asynchronous communication management process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for managing asynchronous communication between an AI avatar and a human representative upon detection of a network failure to establish a real-time connection comprising:
executing codes using one or more processors of a computer system to cause the computer system to perform operations comprising:
detecting a connection failure during an interactive session of the AI avatar with a user, wherein the AI avatar continuously monitors a network status associated with the session with the human representative and identifies an inability to establish or maintain a direct, real-time connection;
dispatching a first notification message by the AI avatar to the human representative through a communication channel upon detection of the connection failure, wherein the first notification message prompting the human representative to provide requested information asynchronously due to the absence of a real-time connection;
receiving an asynchronous response message by the AI avatar from the human representative, wherein the response message includes information relevant to the context of the interactive session of the AI avatar with the user and is received via the communication channels for asynchronous interaction;
updating a knowledge base of the AI avatar by parsing the received asynchronous response message, analyzing the content for relevance to the session context, and incorporating the newly received information into the knowledge base to refine future interactions and responses related to similar user queries; and
sending by the AI avatar a second notification to the user through the communication channel, wherein the second notification informs the knowledge base has been successfully updated with the new information provided by the human representative, thereby enabling the user to stay informed regarding the updated state and knowledge content of the AI avatar for subsequent interactions.

2. The method of claim 1 wherein the first notification message is transmitted through the communication channels comprising:
a mobile application message directed to a mobile application associated with the account of the human representative, and
an email message directed to an email address associated with the account of the human representative.

3. The method of claim 1 wherein the connection failure is detected by a network monitoring module configured to continuously track connectivity status between the AI avatar and the human representative during the session.

4. The method of claim 1 wherein the AI avatar uses a connection monitoring algorithm that performs continuous or interval-based network status checks by:
detecting a connection failure when network latency, packet loss, or disconnection exceeds a predefined threshold, and
subsequently triggering the dispatch of the first notification message to ensure prompt and reliable communication with the human representative regarding the connection status.

5. The method of claim 1 wherein the knowledge base update involves a data processing algorithm executed by the AI avatar to:
parse and analyze the content of the response message provided by the human representative,
extract specific information relevant to the session, and
incorporate the extracted information into a structured, query-specific knowledge base entry, thereby enhancing the ability of the AI avatar to address similar queries with improved accuracy in future sessions.

6. The method of claim 1 wherein the notification handling algorithm deployed by the AI avatar triggers the second notification to dispatch specifically to the user who initiated the session, the second notification conveying details on the updated knowledge base entries, enabling the user to track and verify the updated information.

7. The method of claim 1, wherein the first notification message dispatched by the AI avatar includes detailed guidance to the human representative on reconnection including information on how the human representative can reconnect, submit responses via different channels, or contact support for additional assistance.

8. The method of claim 1 wherein the data processing algorithm employed by the AI avatar includes:
context analysis to validate the relevance of the response provided by the human representative to the original query context, and
categorizing and indexing the response within the knowledge base to ensure that the update is specifically aligned with the query topic for use in similar future interactions.

9. A system for managing asynchronous communication between an AI avatar and a human representative upon detection of a network failure to establish a real-time connection comprising:
one or more processors;
memory, operatively coupled to the one or more processors that when executed cause the one or more processors to perform operations comprising:
executing codes using one or more processors of a computer system to cause the computer system to perform operations comprising:
detecting a connection failure during an interactive session of the AI avatar with a user, wherein the AI avatar continuously monitors a network status associated with the session with the human representative and identifies an inability to establish or maintain a direct, real-time connection;
dispatching a first notification message by the AI avatar to the human representative through a communication channel upon detection of the connection failure, wherein the first notification message prompting the human representative to provide requested information asynchronously due to the absence of a real-time connection;
receiving an asynchronous response message by the AI avatar from the human representative, wherein the response message includes information relevant to the context of the interactive session of the AI avatar with the user and is received via the communication channels for asynchronous interaction;
updating a knowledge base of the AI avatar by parsing the received asynchronous response message, analyzing the content for relevance to the session context, and incorporating the newly received information into the knowledge base to refine future interactions and responses related to similar user queries; and
sending by the AI avatar a second notification to the user through the communication channel, wherein the second notification informs the knowledge base has been successfully updated with the new information provided by the human representative, thereby enabling the user to stay informed regarding the updated state and knowledge content of the AI avatar for subsequent interactions.

10. The system of claim 9 wherein the first notification message is transmitted through the communication channels comprising:
a mobile application message directed to a mobile application associated with the account of the human representative, and
an email message directed to an email address associated with the account of the human representative.

11. The system of claim 9 wherein the connection failure is detected by a network monitoring module configured to continuously track connectivity status between the AI avatar and the human representative during the session.

12. The system of claim 9 wherein the AI avatar uses a connection monitoring algorithm that performs continuous or interval-based network status checks by:
detecting a connection failure when network latency, packet loss, or disconnection exceeds a predefined threshold, and
subsequently triggering the dispatch of the first notification message to ensure prompt and reliable communication with the human representative regarding the connection status.

13. The system of claim 9 wherein the knowledge base update involves a data processing algorithm executed by the AI avatar to:
parse and analyze the content of the response message provided by the human representative,
extract specific information relevant to the session, and
incorporate the extracted information into a structured, query-specific knowledge base entry, thereby enhancing the ability of the AI avatar to address similar queries with improved accuracy in future sessions.

14. The system of claim 9 wherein the notification dehandling algorithm deployed by the AI avatar triggers the second notification to dispatch specifically to the user who initiated the session, the second notification conveying details on the updated knowledge base entries, enabling the user to track and verify the updated information.

15. The system of claim 9 wherein the first notification message dispatched by the AI avatar includes detailed guidance to the human representative on reconnection including information on how the human representative can reconnect, submit responses via different channels, or contact support for additional assistance.

16. The system of claim 9 wherein the data processing algorithm employed by the AI avatar includes:
context analysis to validate the relevance of the response provided by the human representative to the original query context, and
categorizing and indexing the response within the knowledge base to ensure that the update is specifically aligned with the query topic for use in similar future interactions.
